(19) United States
(12) Patent Application Publication
(10) Pub. No.: US 2002/0019757 A1
(43) Pub. Date: Feb. 14, 2002

(54) Online work order processing for the print industry

(76) Inventors: Peter Dodt, Birmingham, AL (US); Lynn Dodt, Birmingham, AL (US)

Correspondence Address: Ellen S. Cogen, Gifford, Krass, Groh, Sprinkle, Anderson & Citkowski, P.C., 280 N. Old Woodward Ave., Suite 400, Birmingham, MI, 48009, US

(21) Appl. No.: 09/773,238

(22) Filed: Jan. 31, 2001

Related U.S. Application Data
(60) Provisional application No. 60/179,318, filed on Jan. 31, 2000.

(51) Int. Cl. G06F 17/60

(52) U.S. Cl. 705/7

(57) ABSTRACT

There is provided an automated system and method that allows a customer, via a software program, to identify a printer, fill out an electronic work order, and transfer electronic data through a series of entry screens to a printer facility via a communications network. The software application also provides for a seamless and invisible relationship between the printer and a prepress provider, wherein the customer files may be directed to an outside prepress house or other service provider for preparation.

### Reference to Related Applications

This application claims priority of U.S. Provisional Patent Application Ser. No. 60/179,318 filed Jan. 31, 2000, the entire content of which is incorporated herein by reference.

### FIELD OF THE INVENTION

The present invention relates generally to work order processing for the print industry; and, more particularly, to a method and system for the submission, receipt, processing and completion of work orders via a wide area communications network.

### BACKGROUND OF THE INVENTION

The print industry is under tremendous technological pressure as new equipment, particularly digital equipment, enters the marketplace. This is relatively new to an industry where presses traditionally have a service life of twenty years or more. With the increase of digital processing and direct-to-plate printing, coupled with the explosion of ecommerce, many printers are searching for cost-effective ways to develop an Internet presence along with a mechanism to electronically or digitally transport customer files.

### SUMMARY OF THE INVENTION

The present invention recognizes the need in the marketplace for printers to be connected to their customers via the Internet, as both a sales tool and a mechanism to speed the transfer of data files. A primary object of the invention is to establish conductivity between members of the print industry, their customers and related service providers through software applications and electronic or digital media transport.

More particularly, the invention provides a software application and method that allows a customer to identify a printer, fill out an electronic work order, and transfer electronic data through a series of entry screens which are customized for the particular printer. The software application also provides for a seamless and invisible relationship between the printer and the prepress provider, wherein files may be directed to an outside prepress house or other service provider for preparation. Since the transfer would be invisible to the customer, this allows the printer to route services to an outside company, taking advantage of the cost savings of outsourcing the services traditionally considered a cost center for printers, while providing the customer with an interface that appears as “one-stop shopping.”

A unique aspect of the invention is that it provides not only the means to transport the electronic data (via the software application), but also the gateway and the optional service of file preparation prior to data transport. All this is achieved seamlessly, so that the customer is exposed only to the printer through an easy-to-use order entry screen.

### BRIEF DESCRIPTION OF THE DRAWINGS

FIG. 1 illustrates a schematic view of a preferred embodiment of the online work order processing invention for the print industry according to the present invention;

FIG. 2 illustrates a diagrammatic view of high level process steps according to the present invention;

FIG. 3 illustrates customer processes associated with automatic work order entry according to the present invention;

FIG. 4 illustrates production processes following the entry of customer orders according to the present invention; and

FIG. 5 illustrates system components and their relationship in an embodiment of the present invention.

### DETAILED DESCRIPTION OF THE PREFERRED EMBODIMENT

In accordance with the present invention, the preferred embodiment of the online work order processing invention for the print industry provides for the automated receipt and processing of work orders and associated data and print files via a communications network such as the Internet. The process includes the means to seamlessly transfer data files received from the customer and related to the work order via a communications network such as the Internet to outsourcing facilities for processing and/or completion of the work order. The preferred embodiment also contemplates use of a single point of online contact such as a website having a series of interfaces specific to one or more printers for customer facilitation and ease of order entry.

Typically, the preferred method utilizes an automated system having a work order component, a data repository, and an outsourcing component as hereinafter described. It is contemplated that the system utilized by the preferred method functions independently of any one hardware or operating system platform. For example, the system configuration coexists with one or more Intel based processors, a Windows NT® operating system, as well as Microsoft SQL® or other database and software components. The automatic system is compatible with a variety of system configurations in a communications network thereby supporting global operations related to work order processing for the print industry.

A preferred method may be implemented in a local, expanded, or global computing environment and integrated with existing print order and prepress systems. It is contemplated that the present invention serves a wide market segment, including customers having local, regional, national and/or international presence, via a communications network.

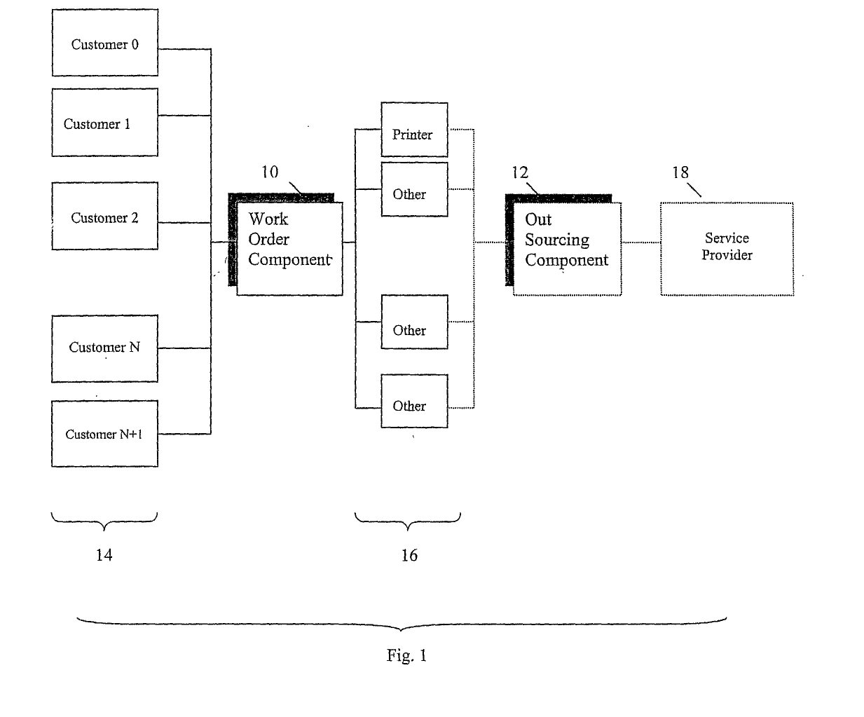

Referring now to the drawings wherein like numbers are used to denote like items throughout, there is shown in FIG. 1 a schematic illustrating a preferred embodiment of the online work order processing invention for the print industry according to the present invention. Typically, the preferred embodiment utilizes one or more software components such as a work order component 10 and an outsourcing component 12 to receive work order requests from one or more customers 14 via a communications network, pass the work orders to a selected printer or other intended destination 16; e.g., an advertising agency. The selected printer determines if the work order entails services that cannot, or will not, be provided by the selected printer, and selects a service provider 18 to complete the outsourced services; e.g., prepress services. The selected printer utilizes outsourcing component 12 to facilitate electronic or digital transmission of the work order request, associated files, and data to the service provider 18.

Once the service provider 18 completes the work-order related services, the resultant product or products are typically routed to the printer for delivery to the customer.

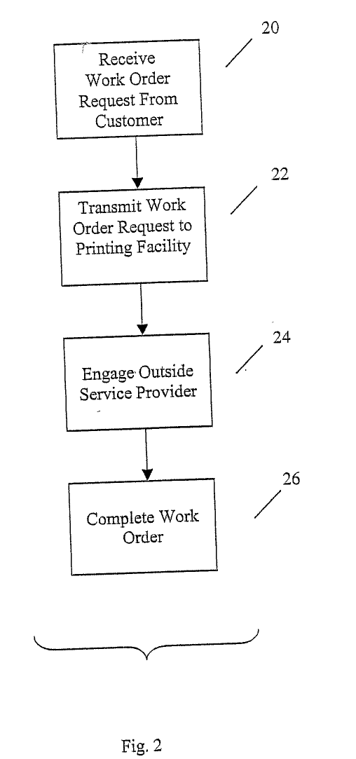

Turning now to FIG. 2, there is shown a diagrammatic view of high-level process steps according to the present invention. Typically, the process steps include receiving a work order request from the customer 20, transmitting the work order request to the printing facility 22, engaging an outside service provider to complete at least a portion of the services requested 24, and completing the work order 26.

Presented in greater detail, the high-level process may be described in terms of two fully integrated subprocesses: a customer process and a production process. The customer process is associated generally with the work order component 10 or other software that permits a user or customer to electronically submit a work order request via the Internet. The work order component 10 allows files and data to be attached and submitted with the work order request and eliminates the physical transport of data. It is assumed that the appropriate hardware has been provided to allow for high-speed transmission of what are normally very large, byte-intensive graphic files.

The production process relates to an aspect of the present invention that allows for seamless transmission between printer, brokers, agencies, and other service providers associated with the printing industry. The production process allows an off-site organization to function as a prepress house and, for example, receive customer files from the printer, turn them into printer-ready paper, composite film, and four-color film separations, and return the material to the printer for delivery to the customer.

Generally, the work order is presented to the customer as part of a printer's website, with prepress services (and perhaps other functions) remaining completely invisible to the end user or customer. Thus, the sender or customer has no knowledge that the files are actually being submitted for prepress services. The printer is notified of an incoming job, but at least the prepress portion is actually routed to a separate entity (the service provider). This not only gives the printer the appearance of an automatic prepress capability, but also allows a value-added service where the customer or end user can submit work order requests with attached files via the electronic process. This greatly reduces turnaround times and widens the printer's marketing area.

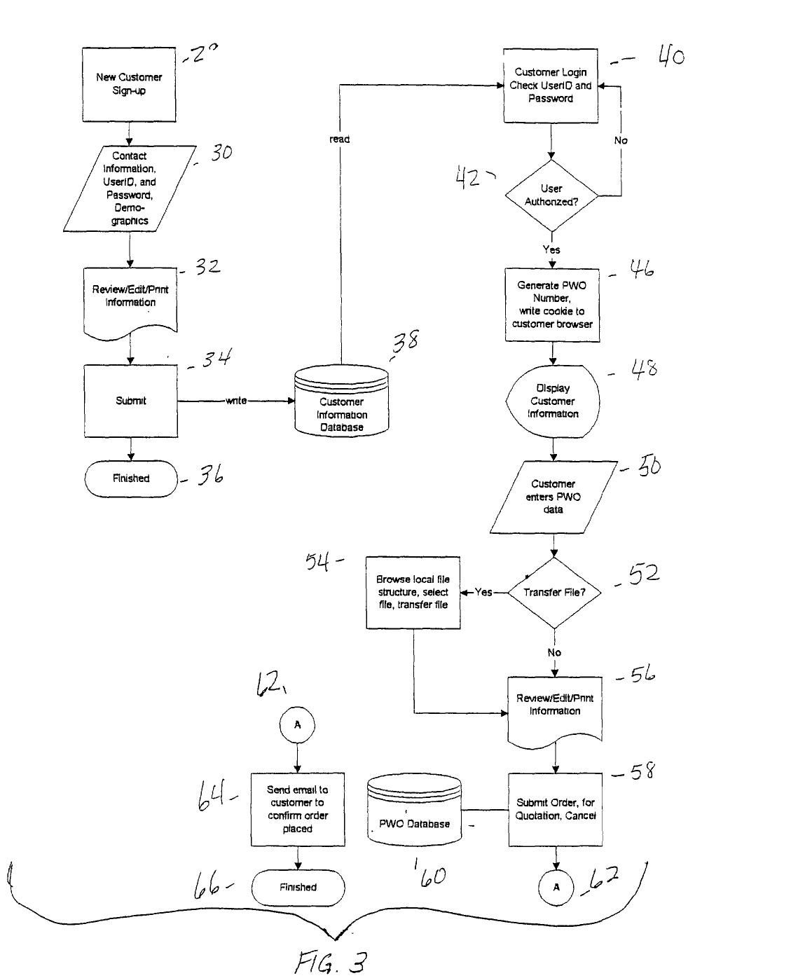

Turning now to FIG. 3, there is shown a flowchart of the customer process associated with automatic work order entry according to the present invention. Broadly, the customer follows two paths: initial signup and project work order (PWO) data entry. The PWO number is tracked throughout the data-entry process by, for example, a cookie stored on the printer's computer. Note that the host processes can be customized, and that the displays would reveal individual host information.

At functional block 28, new customer sign-up information is entered, as well as at block 30, where user ID, password and demographics are compiled. The information is edited at 32, and submitted at 34. Having written the information to a customer database 38, this particular routine finishes at 36.

At block 40, information is read from the customer database 38, so as to check user ID and password. If the user is not authorized at question 42, processing does not proceed; however, if the user is authorized, a PWO number is generated and a cookie written to the customer computer to be displayed at the location of the customer at step 48. At this point, block 50, the customer enters the work order data, whereafter the information is iteratively reviewed and edited at 56 until the file is in condition for transfer through block 54. The order is submitted at 58 into an administration database for work order details 60. After submission of the order at 58, the routine passes to a subroutine A at 62, where an email is sent to the customer to confirm placement of the order, after which the customer process finishes at 66.

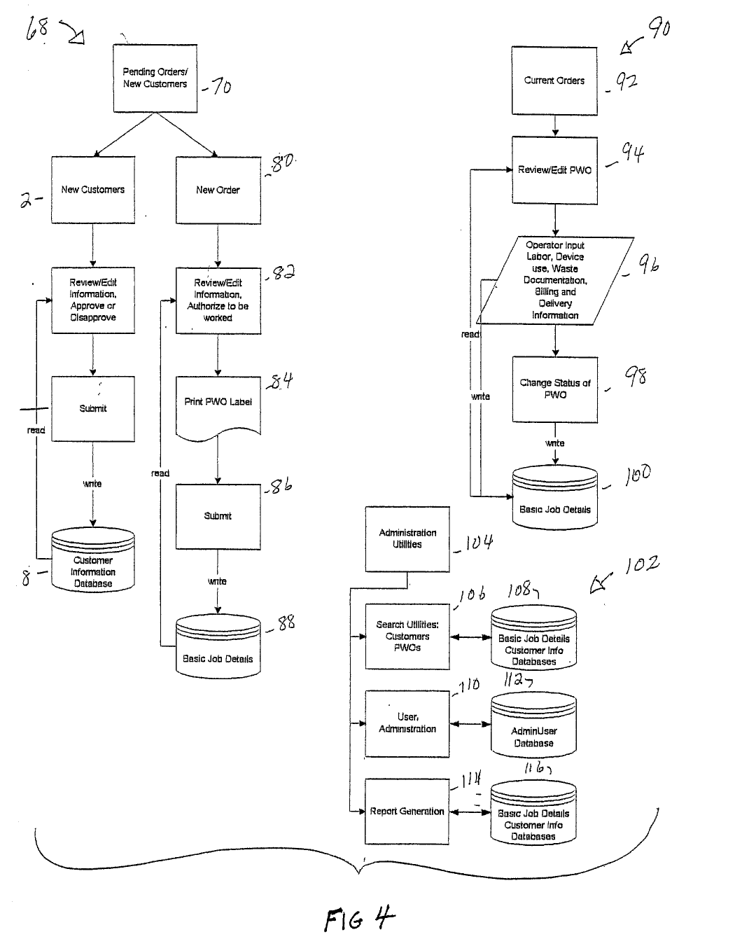

Referring now to FIG. 4, there are shown production processes following the entry of customer orders according to the present invention. Flowchart 68 shows processes used to authorize new customers and new project work orders. After a new customer is authorized, the customer may submit new work orders for processing without having to go through the initial steps associated with new customer entry. New work orders are reviewed for information completeness, then transmitted for completion through internal operations. The pending orders or new customers are entered at block 70. In the case of a new customer, at 72, the information is iteratively reviewed, edited, and approved at 74, submitted at 76, and written to a customer information database 78. In the case of a new order, at block 80, a slightly different iterative process is invoked, wherein information pertinent to the new order is reviewed, edited, and the work authorized at 82. A PWO label is printed at 84, and the basic job details are written 86 into a basic job details database depicted at 88.

The operations depicted in flowchart 90 are used primarily by internal personnel, enabling an operator to review the work to be performed, document the work that has actually been performed, and review information associated with operational efficiency. Billing and delivery information is also documented on the work order. After the work is completed, the status of the PWO is modified to show that the work has been done. Current orders are entered at 92, and are reviewed at 94 by reading a basic job detail database shown at 100, having been written through operator inputs at 96 involving labor, operational waste, billing and delivery. If the status of the PWO changes at 98, this information is also taken into consideration when writing the basic job detail database at 100.

Flowchart 102 involves the administration utilities used by management to perform a number of operations, such as month-end billing reports, lookup information on customers and work orders, and basic user management. Administration utilities at block 104 are available to a plurality of processes, including search utilities for customer PWOs at 106 that interact with the basic job detail and customer information databases 106, user administration at 110, that interacts with a user administration database 112, and the report generation carried out at 114 interacts with the database 116 involving basic job details, customer information, and so forth.

In another embodiment, a system is provided for the receipt, processing, seamless routing of work order requests, data, and files by and between printers and associated service providers.

Typically, the system uses the Internet or a similar communications network for transfer of the work order requests, data, and files. The system generally comprises a work order component for receiving work orders and files; a storage component for storing data related to the work orders and the customers; and an outsourcing component for receiving and processing files based on the work order.

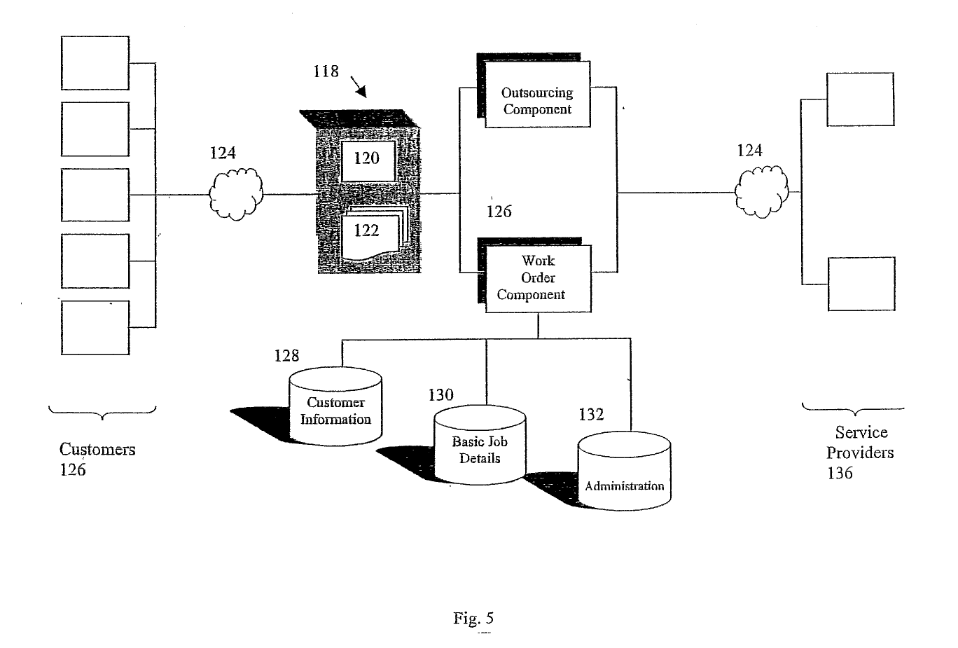

Turning now to FIG. 5, there is shown a schematic of the system having a plurality of components and the relationships therebetween. In the system, a website server 118 having a suite of software 120 and a customer interface 122; e.g., a plurality of webpages customized for a printer. One or more customers 126 utilize a computer or electronic device to access the webserver 118 via a communications network 124 such as the Internet.

Upon access to the webserver 118, the customer utilizes a browser and an input device such as a keyboard to view the customer interface 122, enter information into designated areas on the webpages, and submit files or other data. Typically, this information includes customer information, work order request information, and the like.

The information is passed to the software, usually the work order component 126 associated with the printer, whereafter the information is processed and stored in a customer information database 128, a basic job detail database 130, or an administration database 132 (also associated with the printer). Following a series of predetermined processing steps, the work order component 126 interacts with various software; e.g., a login component, to generate and email various information to the customer. The information includes, for example, a login, a sales quotation based on the work requested, a PWO, and a confirmation of receipt of the customer's files.

The work order component 126 also selects a portion or all of the information electronically or digitally passed to the outsourcing component 134 for analysis and determination of work order requirements pertinent to outside services. Once the analysis and determinations are complete, the outsourcing component routes the work order, information, related files, etc. to one or more service providers 136 via a communications network 124 such as the Internet.

Alternatively, the website server 118 and its associated software 120 bypass the storage repositories typically associated with a printer and electronically or digitally forward the work order request, information, files, etc. directly to outsourcing component 134 for delivery to one or more service providers 136 via the communications network 124.

Upon completion of the services by the service provider 136, the products are electronically or digitally forwarded to the work order component 126 for finalization services, if necessary, and delivery to the customer.

In summary, a system and process has been described whereby online work orders may be completed using outside vendors without a customer necessarily being aware that services were not provided by the entity with which the customer primarily interacts. It should be noted that the invention is not limited to any type of function provided by an outside service provider, and would naturally extend to any function that the entity with which the customer interacts is either unwilling or unable to perform. In the print industry, for example, this might include any sort of function related to graphic arts, including layout, stripping, color separations, screen preparation, special type font acquisition, engraving, embossing, stamping, die-cutting, folding, adhesive/sealing, trimming, and so forth. For that matter, printers may engage the services of other printers so as to realize special functions or lower prices. For example, a printer having only a four-color press may engage the services of a printer having a six-color press, a web press, a letter press, or some other piece of equipment that may not physically reside at the primary printing facilities. Therefore, the foregoing examples represent several of the embodiments of the present invention; however, one skilled in the art will recognize that the invention described herein may be implemented in a variety of ways. Therefore, the foregoing examples should be considered illustrative only, and not a limitation of the present invention.

We claim:

1. A method of automatically fulfilling a work order associated with a print job request by a customer in communication with a printing facility via a communications network, the method comprising the steps of:
receiving a work order request from a customer;
transferring the work order to the printing facility over the communications network;
engaging an outside service provider to perform the service which the printing facility is either unable or unwilling to perform; and
completing the work order without the customer necessarily being aware that the outside service provider was engaged.

2. The method of claim 1, wherein the service performed by the outside service provider is a prepress service.

3. The method of claim 1, further comprising the step of providing an interface component.

4. The method of claim 1, further comprising the steps of receiving data via the communications network from the customer and incorporating the data into a portion of the work requested.

5. An automated system to provide seamless work order receipt and processing services via a communications network for a customer, the system comprising the steps of:
providing a selection of printers via a communications network;
receiving a designation for a printer from the selection of printers via a communications network;
providing a set of interface screens customized to the designated printer via a communications network;
receiving the work order request and data associated with the set of interfaces via a communications network;
providing at least a portion of the data and the work order to a service provider; and
processing at least a portion of the work order with the provided portion of the data.

6. The system of claim 5, further comprising the step of providing the processed work order to the customer via the communications network.

7. The system of claim 5, wherein the data further comprises customer information.

8. The system of claim 7, further comprising the step of storing the customer information.

9. The system of claim 7, further comprising the step of issuing a login associated with the customer information.

10. The system of claim 5, wherein the data further comprises a file.

11. The system of claim 10, further comprising the step of converting the file to a portion of the work order.

12. The system of claim 5, further comprising providing a quotation related to the work order request.

13. An automated system for receiving via a communications network and processing work order requests and files for printing-related activities, the automated system comprising:
a work order component;
a storage component in communication with the work order component; and
an outsourcing component in communication with the work order component, the storage component, or both.

14. The system of claim 13, wherein the communications network further comprises the Internet.

15. The system of claim 13, further comprising a website available via the communications network.

16. The system of claim 15, wherein the website further comprises an interface component.

17. The system of claim 13, wherein the storage component further comprises a customer information database.

18. The system of claim 13, wherein the storage component further comprises an administration database.

19. The system of claim 13, wherein the storage component further comprises a basic job detail database.

20. The system of claim 13, further comprising a login component.
